(19) United States
(12) Patent Application Publication
(10) Pub. No.: US 2008/0185222 A1
(43) Pub. Date: Aug. 7, 2008

(54) WORKING PLATFORM

(76) Inventors: Guenther Herrmann, Guetersloh (DE); Burkhard Zachewicz, Marienfeld (DE)

Correspondence Address: Striker, Striker & Stenby, 103 East Neck Road, Hungtington, NY, 11743, US

(21) Appl. No.: 11/834,278

(22) Filed: Aug. 6, 2007

(30) Foreign Application Priority Data
Aug. 7, 2006 (DE) 10 2006 037 107.0

(51) Int. Cl. E06C 5/00

(52) U.S. Cl. 182/69.4

(57) ABSTRACT

A working platform has a ground drive, a platform, a telescoping support unit having one end connected to the ground drive and another end connected to the platform, an adjusting unit for extending and retracting the telescoping support unit for expanding and retracting the support unit, the support unit including support segments which are at least partially nested inside each other, the adjusting unit being assigned to a displaceable support unit segment of the support unit segments.

### CROSS-REFERENCE TO A RELATED APPLICATION

The invention described and claimed hereinbelow is also described in German Patent Application DE 10 2006 037 107.0 filed on Aug. 7, 2006. This German Patent Application, whose subject matter is incorporated here by reference, provides the basis for a claim of priority of invention under 35 U.S.C. 119(a)-(d).

### BACKGROUND OF THE INVENTION

The present invention relates to a working platform with a chassis.

From the related art, e.g., U.S. Pat. No. 4,930,598, working platforms are known, with which a joint construction—similar to a scissors lift—is used as the support means for the working platform. By actuating individual joint elements it is possible to adjust the height of the working platform. The disadvantage of working platforms of this type is that they require a relatively large amount of material, and the fact that, in the retracted state, the remaining height is relatively great, since the scissors lift arms are typically supported on a ground drive frame, resting on each other, when in the transport position.

To counteract these disadvantages, working platforms have also been made known, the support means of which can be extended and retracted in a telescoping manner. Reference is made to DE 103 35 687 as an example, in which a working platform is disclosed, the platform of which is connected with the chassis of the ground drive. The telescoping support means are located between the working platform and the chassis such that they cross each other. At least two support means are positioned parallel to each other, and the further support means are located between them. Reciprocating cylinder systems for extending and retracting the telescope segments are described, which are assigned to the particular support means in the region of its main tube.

Since the main tube of the support means is connected with the chassis of the ground drive in each case, designs of this type have the particular disadvantage that the piston rods of the reciprocating cylinder systems must cover very long distances in order to move the working platform from a transport position into a desired working position. A significant disadvantage of reciprocating mechanisms of this type is that reciprocating cylinders require a relatively great deal of installation space and, given that the distances to be covered by the piston rods are long, slight positional deviations in the bearings of the reciprocating cylinders can result in considerable strain when the piston rod is extended. To counteract the latter, publication DE 103 35 687 provides, e.g., that the extension and retraction motion of the support means segments be realized at least partially using chain drives. Drives of this type have more complex designs, however, and they have the disadvantage that it is not entirely possible to realize highly-precise positionings of the working platform in the vertical direction. In the exemplary embodiment described in DE 103 35 687, the precise positioning of the working platform is limited solely to the motion of the working platform on the ground, since the ground drive of the working platform has Mecanum wheels, which are usually designed as described in DE 38 41 971.

A characteristic feature of land wheels with this design is that they include a wheel body formed by adjacent support elements. The support elements rotatably accommodate a large number of rolling bodies between each other and on a peripheral circle. The rolling bodies extend at least partially beyond the circumference of the support elements and their axes of rotation are oriented diagonally to the land wheel axle of the wheel body. Given that a land wheel of this type is rotatable around its land wheel axle, and the rolling bodies are rotatable around their longitidual axes, a ground drive having this design can carry out highly precise changes in direction and, in the extreme case, can allow rotation on the spot or make a precise 90° change in the direction of motion.

### SUMMARY OF THE INVENTION

The object of the present invention, therefore, is to avoid the described disadvantages of the related art and, in particular, to provide a working platform that has a compact design and allows precise positioning of the working platform.

In keeping with these objects and with others which will become apparent hereinafter, one feature of the present invention resides, briefly stated, in a working platform, comprising a ground drive; a platform; telescoping support means having one end connected to said ground drive and another end connected to said platform; adjusting means for extending and retracting said telescoping support means for expanding and retracting said support means, said support means including support means segments which are at least partially nested inside each other, said adjusting means being assigned to a displaceable support means segment of said support means segments.

Given that the working platform includes telescoping support means capable of being activated by adjusting means for vertically extending a working platform relative to the ground drive of the working platform, and the support means are formed by support means segments, which are at least partially nested inside each other, and the at least one adjusting means is assigned to a displaceable support means segment, it is ensured that the working platform has a compact design that saves installation space, and that a highly precise positioning of the working platform is attainable. The latter is possible, in particular, since shorter adjusting means can now be used, the shorter displacement paths of which also result in shorter, tolerance-related positional deviations, which ultimately greatly or entirely eliminates constraining forces in the system.

An implementation of the design having a simple design results, in particular, when the support means are formed by three support means segments, which are at least partially nested inside each other, and the at least one adjusting means are assigned to the center support means segment.

In an advantageous refinement of the present invention, the adjusting means are designed as a reciprocating cylinder system, which includes at least one piston rod coupled with the chassis of the ground drive and a piston rod coupled with a working platform. As a result, when pressure is applied to the reciprocating cylinder system, the working platform can be continually extended in the vertical direction relative to the ground drive. The vertical position can be changed highly precisely since the adjusting means are designed as reciprocating cylinders.

A rapid and even displacement of the working platform can be attained when the reciprocating cylinder system is designed as a synchronous cylinder system such that the reciprocating cylinder system includes a first reciprocating cylinder and a further reciprocating cylinder that are coupled with the same displaceable support means segment and with each other via a line system such that the piston-rod side pressure chambers and the piston-surface side pressure chambers of the reciprocating cylinders are interconnected. This effect will become greatest when, according to an advantageous embodiment of the present invention, all piston-rod side pressure chambers and all piston-surface side pressure chambers of the reciprocating cylinders assigned to the particular support means are interconnected.

To prevent overloads and related disturbances when the working platform is displaced, it is provided in an advantageous embodiment of the present invention that the line system of the reciprocating cylinders includes at least one non-return valve and a pressure reservoir unit.

An optimal use of the limited installation space also results when, according to an advantageous refinement of the present invention, the pressure reservoir medium is guided inside the piston rods of the adjusting means designed as reciprocating cylinders.

To prevent constraining forces from forming while the working platform moves, which would also have negative effects on the highly precise positioning of the working platform, it is also provided that the reciprocating cylinders and/or the support means segments connected with the chassis of the ground drive and the working platform are connected using swivel joints, preferably using ball joints, to the chassis and the working platform. In this manner, the reciprocating cylinders and the support means segments can move with a large number of degrees of freedom around their pivot points.

In a further advantageous embodiment of the present invention, at least one swivel joint of a support means and/or a reciprocating cylinder is designed as a compound slide joint. This has the advantage, in particular, that, in order to compensate tolerance-related positional deviations to prevent constraining forces, the various pivot points of the reciprocating cylinders and the support means can perform swivel motions, and pushing motions transversely to the longitudinal direction of the working platform.

A design of the support means that saves installation space and holds the working platform securely in the working position results in an advantageous embodiment of the present invention when at least three support means are provided between the ground drive and the working platform, which cross each other and connect the working platform with the ground drive; at least two support means are located parallel to each other, and at least one further support means are located between the parallel support means.

To ensure that the position of the working platform can be adjusted very precisely and that slanted positions of the working platform can be attained precisely, it is provided in a further advantageous embodiment that a cable tension sensor is assigned to each of the support means such that the guide cable detects the change in length of the particular support means. The accuracy of the positioning of the working platform is improved even further when the tilt of the working platform resulting from unevenness on the ground is taken into account when the working platform is moved. This can be attained, e.g., by assigning a tilt sensor for determining the tilt of the working platform to the ground drive and/or the support means and/or the working platform, at the least.

It is possible to process the change-in-length signals that were detected into a precise positioning of the working platform in a manner that is effective, operates efficiently, and is easily implemented when the change in length of the particular support means is encoded in actual length signals, and the actual length signals are compared in a control and regulating unit with target length signals and, if the detected actual length signals agree with the specified target length signals, stop signals are generated by the control and regulating unit to halt the motion of the support means segments.

In an analogous manner, the precise positioning is also supported by the fact that, in an advantageous embodiment of the present invention, the change in length of the particular support means is encoded in actual length signals, and the actual length signals are compared in a control and regulating unit with target length signals—the comparison taking into account the tilt of the working platform determined via tilt signals generated by the tilt sensors—and, if the detected actual length signals agree with the specified target length signals, stop signals are generated by the control and regulating unit to halt the motion of the support means segments.

A highly precise positioning of the working platform as such on the ground is attained in an advantageous embodiment of the present invention when the ground drive includes a large number of land wheels, and the land wheels include a wheel body formed by adjacent support elements; the support elements rotatably accommodate a large number of rolling bodies between each other and on a peripheral circle, and the rolling bodies extend at least partially beyond the circumference of the support elements, and their axes of rotation are oriented diagonally to the land wheel axle of the wheel body.

Precise positioning and secure driving of the working platform on ground is also support when, in an advantageous embodiment of the present invention, the outer contour of at least one rolling body has an elliptical shape, and the geometry of this ellipse is adapted to the geometry of the cylindrical envelope described by the rolling bodies of the land wheel when it rotates around the land wheel axle.

Traveling across precise routes on ground can also be optimized by assigning at least one hydromotor for actively driving the particular land wheel to each land wheel of the ground drive, and using an electrical control circuit to provide the hydraulic oil medium, since hydromotors can run at very slow rpm's and implement very small angles of rotation of the land wheels.

In an advantageous embodiment of the present invention, the ground drive includes paired land wheels; a wheel motor is assigned to at least one of the land wheels in the pair, so that the ground drive can support greater loads on the ground, while the costs for the wheel drive system remain reasonable. In this context it is also feasible, however, that a wheel motor is assigned to each land wheel, so that much greater drive power can be transmitted—for which manufacturing costs will increase—and greater masses can therefore be moved by the working platform. A highly energy efficient drive structure is attained when, in an advantageous refinement of the present invention, a wheel motor is assigned to each of the paired land wheels, and the drive of at least one of the wheel motors of the paired land wheels is limited to overcoming the rolling friction between the particular land wheel and the ground. As a result, this land wheel does not perform an active drive function for the working platform.

Given that the electrical control circuit is battery-operated, and a battery regulator assigned to the battery provides only so much electrical energy that the pump capacity of the hydraulic oil medium exactly matches the power output of the driven land wheels, it is ensured that the storage capacity of the battery is used optimally, and the land wheels can be controlled in a nearly ideal manner to implement the necessary motions.

To prevent the support means from making rolling motions when the working platform is being positioned, it is provided in a further advantageous embodiment that the support means segments that are at least partially nested inside of each other in a telescoping manner have a prismatic cross-section.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of the in working platform in accordance with the present invention.

FIG. 2 is a detailed view of a support means of the working platform in a accordance with the present invention.

FIG. 3 is a side view of the inventive working platform in accordance with the present invention.

FIG. 4 is a detailed view of a land wheel of the working platform in accordance with the present invention.

### DESCRIPTION OF THE PREFERRED EMBODIMENTS

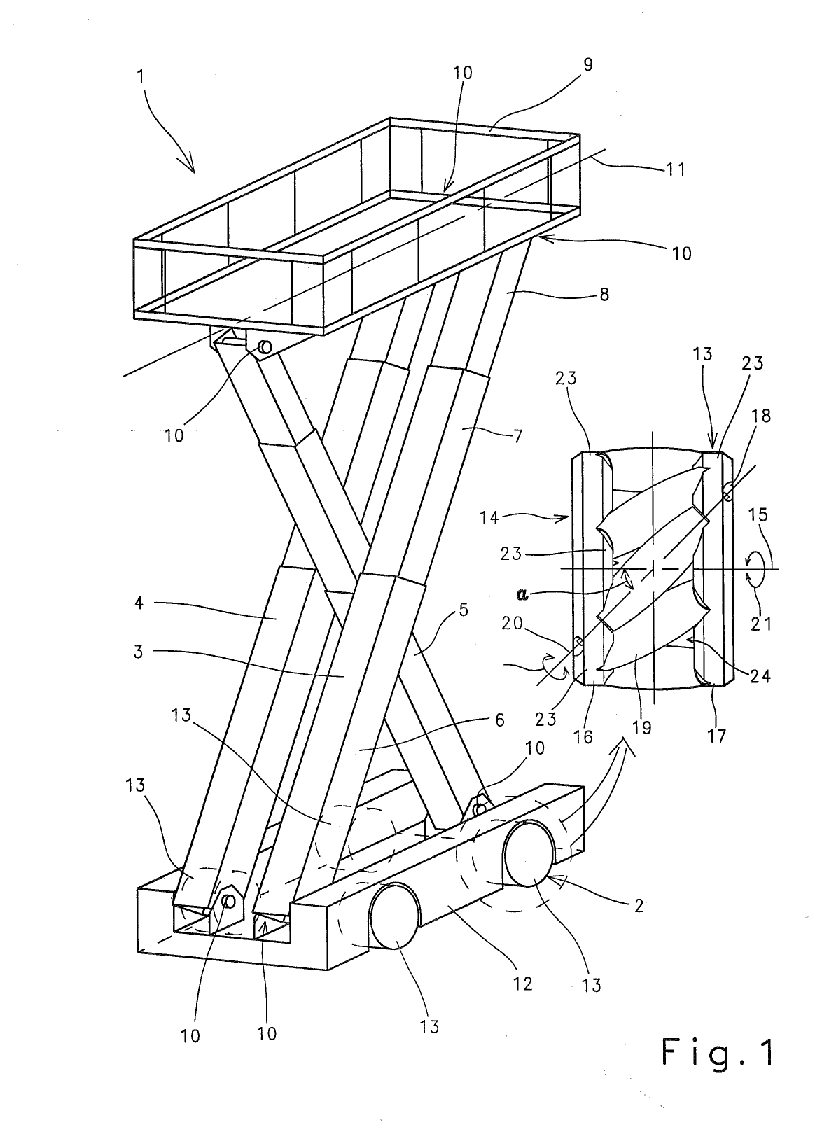

FIG. 1 is a perspective view of an embodiment of a working platform 1 with a ground drive 2, to which three support means 3, 4, 5 are pivotably attached. Support means 3, 4, 5 are designed as telescoping masts composed of support means segments 6, 7, 8, to the ends of which a working platform 9 is attached. The ends of support means 3, 4, 5 are hingedly connected to the underside of working platform 9, thereby making it possible for working platform 9 to move vertically, by extending or retracting support means segments 6, 7, 8.

The hinged connection of support means 3 through 5 with ground drive 2 and working platform 9 is realized using swivel joints 10, which will be described in greater detail. In the exemplary embodiment shown, two support means 3, 4 are positioned in parallel and are located on ground drive 2 and working platform 9 via swivel joints 10 such that support means 3, 4 extend somewhat diagonally from one side of ground drive 2 to the opposite side of working platform 9. A third support means 5 extends between support means 3, 4, forming a cross; third support means 5 are pivotably connected to the other end of ground drive 2 and the opposite end of working platform 9. In the embodiment shown, working platform 9 is shown in a raised position. It is clear that a three-point support of working platform 9 is realized by placing the platform-side ends of support means 3 through 5 on and symmetrically to center line 11 of rectangular working platform 9. This results in stable support of working platform 9 during a vertical motion and in the fixed state.

In the exemplary embodiment shown, ground drive 2 is formed by land wheels 13, each of which is hingedly installed in chassis 12 of ground drive 2.

As shown in the enlarged view in FIG. 1, land wheels 13 are designed as Mecanum wheels. Wheel body 14 of land wheels 13 of this type includes land wheel axle 15—which is indicated using dashed lines—and adjacent support elements 16, 17, which bound the land wheel width on both sides and are non-rotatably connected with land wheel axle 15. Support elements 16, 17 include openings 18 located at regular intervals on a common peripheral circle. Not-shown bearing seats of rolling bodies 19 assigned to the circumferential surface of land wheel 13 pass through openings 18. Rolling bodies 19 are accommodated in a freely rotatable manner by support elements 5, 6. Axis of rotation 20 of each rolling body 19 is positioned at an angle to land wheel axle 15 of particular land wheel 13. The slanted position of rolling bodies 19 is due to angle α between land wheel axle 15 and particular axis of rotation 20, as seen from the front.

Given that land wheel 13 can rotate around its own land wheel axle 15 as indicated by arrow directions 21, in the clockwise and counterclockwise directions, and given that each rolling body 19 can also rotate around its axis of rotation 20 indicated by arrow direction 22 in the clockwise or counterclockwise direction, a vehicle provided with land wheels 13 of this type are provided with the capability—in a manner known per se—to perform very precise motions in highly diverse directions of motion. Shielding regions 23 are also integrally formed on support elements 16, 17 assigned to both sides of wheel body 14, in their radially outward regions. Shielding regions 23 extend at least partially into the region between adjacent rolling bodies 19, so that open spaces 24 resulting between consecutive rolling bodies 19 are shielded to a large extent. In particular, this prevents obstacles lying on the ground being traveled over by land wheel 13 from entering these open spaces 24 and possibly damaging land wheel 13.

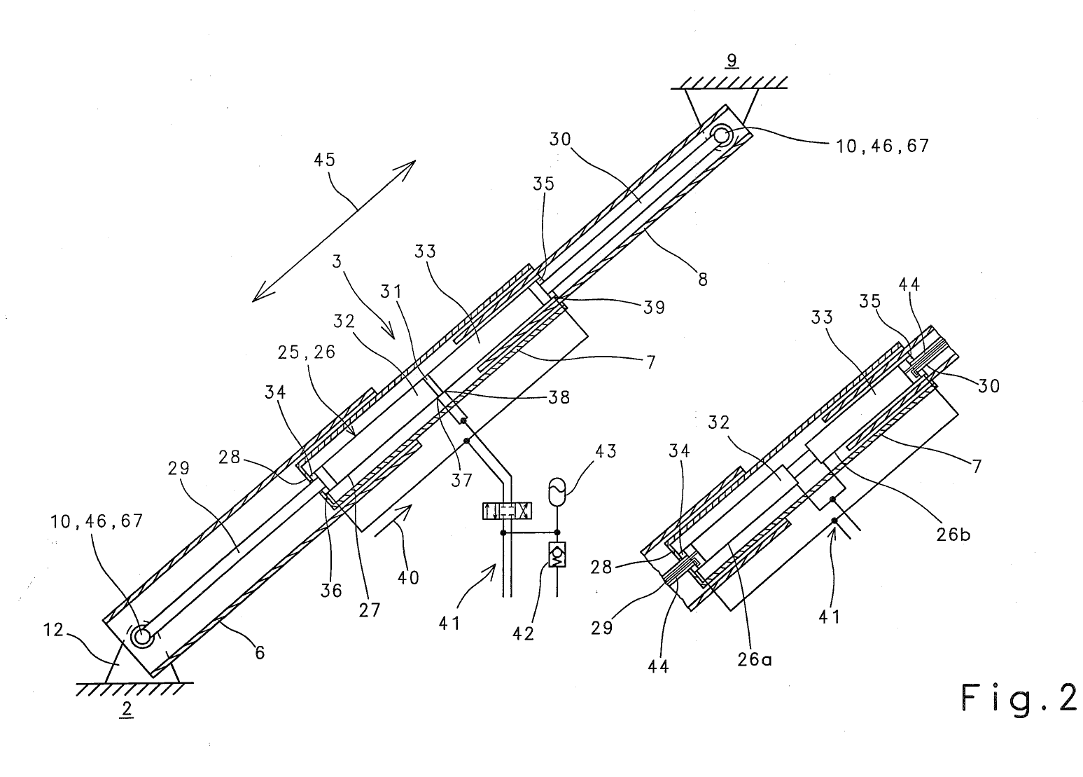

FIG. 2 illustrates the design of adjusting means 25, which bring about the retraction and extension motion of support means segments 6 through 8, using support means 3 as an example. In FIG. 2, adjusting means 25 are designed as double-acting reciprocating cylinder 26, the cylinder hull 27 of which is connected in a frame-fixed but detachable manner with the middle, displaceable support means segment 7 using one or more flange connections 28. In the simplest case, piston rod 29—which extends through lower support means segment 6 hingedly connected with chassis 12 of ground drive 2—is also connected to chassis 12 of ground drive 2 via joint connection 10 of lower support means segment 6. Similarly, and in the simplest case, piston rod 30—which extends through upper support means segment 8 hingedly connected with working platform 9—is also attached to working platform 9 via joint connection 10 of upper support means segment 8. Furthermore, a separating segment 31 is assigned to cylinder hull 27, which seals off piston-surface side pressure chambers 32, 33 of reciprocating cylinder 26 from each other, thereby preventing the motions of the piston rods from influencing each other. Due to the presence of separating segment 31, each of the piston-rod side pressure chambers 34, 35 and piston-surface side pressure chambers 32, 33 have at least one inlet port 36 through 39, via which an oil flow 40 can be directed toward or away from reciprocating cylinder 26.

Depending on whether pressure is applied to piston-rod side pressure chambers 34, 35 or piston-surface side pressure chambers 32, 33, piston rods 29, 30 extend into or retract out of cylinder hull 27. Due to hinged connection 10 of piston rods 29, 30 and lower or upper support means segment 6, 8 with chassis 12 or working platform 9, the application or release of pressure results in the telescopic displacement of support means segments 6 through 8 relative to each other, support means segments 6 through 8 being at least partially nested inside each other. When piston rods 29, 30 extend, working platform 9 is moved upward in the vertical direction. When piston rods 29, 30 are retracted, working platform 9 is moved from a working position into a transport position on chassis 12 of ground drive 2.

Given that piston-rod side pressure chambers 34, 35 and piston-surface side pressure chambers 32, 33 of reciprocating cylinder 26 are now short-circuited, pressure is applied to or relieved from interconnected pressure chambers 32 through 35 at the same time via oil flow 40, and reciprocating cylinder 26—which is designed as a synchronous cylinder—operates. With reference to reciprocating cylinders 26 assigned to the same support means 3 through 5, a nearly even extension or retraction of piston rods 29, 30 of reciprocating cylinder 26 is thereby brought about, and displaceable support means segments 6 through 8 cover nearly the same distances. When piston-rod side pressure chambers 34, 35 and piston-surface side pressure chambers 32, 33 of all reciprocating cylinders 26 assigned to various support means 3 through 5 are now interconnected, this has the advantage that all support means 3 through 5 undergo nearly the same change in length when pressure is applied to or released from reciprocating cylinders 26, thereby preventing strains that would result due to different changes in length of individual support means 3 through 5.

To prevent or dampen load-dependent pressure peaks, hydraulic circuit 41 supplying reciprocating cylinder 26 can include at least one non-return valve 42 and/or one pressure reservoir 43. Similarly, reciprocating cylinder 26 according to the depiction shown on the right in FIG. 2 can also be replaced with two double-acting reciprocating cylinders 26a, 26b. Each of these reciprocating cylinders 26a, 26b is assigned to displaceable support means segment 7 using a suitable number of flange connections 28, which were described above. Depending on the design of support means segments 7, reciprocating cylinder(s) 26, 26a, 26b can be assigned to displaceable support means segment 6 on the inside or outside.

In analogy to reciprocating cylinder 26 designed as one piece, paired reciprocating cylinders 26a, 26b can be incorporated in hydraulic circuit 41 such that piston-rod side pressure chambers 34, 35 and piston-surface side pressure chambers 32, 33 of particular reciprocating cylinder 26b, 26a are interconnected, so that pressure is applied to particular pressure chambers 32 through 35 at the same time via an oil flow 40, or pressure is relieved therefrom at the same time by directing oil flow 40 away. It is within the scope of the present invention for reciprocating cylinders 26, 26a, 26b to be located between swivel joints 10 in a manner that allows them to swing freely, thereby making it possible to eliminate traditionally designed flange connections 28.

Due to the limited amount of installation space available inside and outside of support means 6 through 8, in an advantageous embodiment of the present invention, piston rods 29, 30 of reciprocating cylinders 26, 26a, 26b can have bores 44 in their interior for guiding oil flow 41 inside reciprocating cylinder 26, 26a, 26b.

Due to displacement paths 45—some of which are long—between the end positions of working platform 9, and to prevent tolerance-related constraining forces, swivel joints 10 described above can be designed as ball joints 46, which are known per se and will therefore not be described in greater detail, thereby enabling piston rods 29, 30 and particular support means segments 6, 8 to be moved in swivel joints 10 with a large degree of freedom. The effect of the compensation of positional deviations is also increased further when at least one swivel joint 10 of support means segments 6 through 6 and reciprocating cylinders 26, 26a, 26b are designed as a compound slide joint 67, which is known per se and will therefore not be described in greater detail. This has the advantage, in particular, that, by using elements coupled with a compound slide joint 67, it is possible to realize transverse displacement in addition to the swiveling motion, thereby enabling particular support means segment 6 through 8 and/or reciprocating cylinder 26, 26a, 26b to be displaced transversely to the longitudinal direction of working platform 1, for compensation of position.

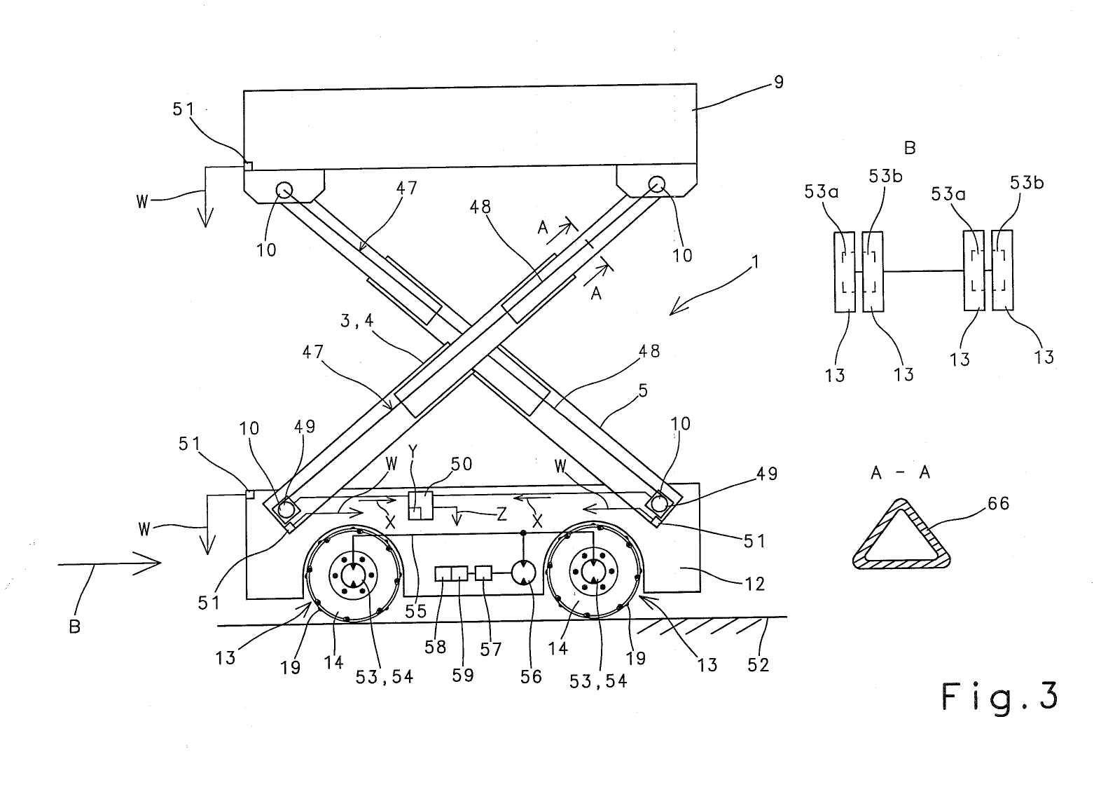

FIG. 3 is a schematic illustration of the desired position of working platform 9. A particularly precise vertical positioning of working platform 9 is attained when a cable tension sensor 47 is assigned to each support means 3 through 5. Cable tension sensors 47 are designed, in a manner known per se, such that a guide cable 48 is used to detect changes in length. In the exemplary embodiment shown, cable rollers 49 for storing guide cable 48 are assigned to swivel joints 10 of each support means 3 through 5 assigned to chassis 12. Guide cable 48 is connected with working platform 9 at the other end. This can be accomplished, as shown, by also coupling guide cable 48 with swivel joints 10 of support means 3 through 5 on the working-platform side. In a manner known per se, the rotational motion of cable rollers 49 and the roll diameter of guide cable 48 on particular cable roller 49 are registered. Using this information, the actual length of unwound guide cable 48 is determined in a control and regulating unit 50 and, based on the known geometry of working platform 1, the position of working platform 9 in three dimensions is determined.

Control and regulating unit 50 is typically designed such that it also controls the extension and retraction motion of support means 3 through 5 based on the definition of a length of particular guide cable 48 to be unwound, thereby enabling working platform 9 to be moved into highly diverse vertical positions depending on the definition of these lengths. Working platform 9 can assume flat or slanted orientations in highly diverse vertical positions. In this context, it would also be feasible to assign tilt sensors 51—which are known per se and are depicted only symbolically—to support means 3 through 5 and/or ground drive 12 and/or working platform 9, preferably chassis 12. Tilt sensors 51 also detect the slanted position of working platform 1 that depends on the slant of ground 52, and this information is taken into account in control and regulating unit 50 when positioning working platform 9. This has the advantage, in particular, that a nearly horizontal position of working platform 9 in three dimensions is always attainable, independently of the evenness of ground 52.

A simple technical implementation of this control and regulating process could be realized, in a manner known per se, when the change in length of particular support means 3 through 5 is encoded in change-of-length signals X, and change-of-length signals X are compared in control and regulating unit 50 with target change-in-length signals Y and, when the detected change in length matches the specified target change in length, stop signals Z are generated to halt the motion of support means segments 6 through 8. In the simplest case, stop signals Z result in the interruption of oil flow 40 in hydraulic circuit 41 depicted in FIG. 2. Similarly, tilt signals W generated by tilt sensors 51 can be taken into account when stop signals Z are generated in control and regulating unit 50.

In addition to the precise positioning of working platform 9 in the vertical direction, the precise positioning of working platform 1 in three dimensions also plays a significant role. This can be carried out that much more precisely, the more precisely ground drive 12 can be moved on the ground. Given that a wheel motor 53 is assigned to each land wheel 13, each land wheel 13 can be controlled individually. Wheel motors 53 are typically controllable such that land wheel 13 assigned to particular wheel motor 53 can be moved at extremely slow rpms and around extremely small angles of rotation, thereby enabling working platform 1 to be moved very precisely, even over very short distances. In the exemplary embodiment shown, wheel motors 53 are designed as hydromotors 54. Hydropump 56 incorporated in hydraulic circuit 55 is controlled via an electrical control circuit 57 in a manner known per se such that individual land wheels 13 can be supplied with hydraulic oil independently of each other. Since working platforms 1 of this type typically include a battery system 58 as the energy source, the efficient use of energy plays a significant role in terms of minimizing time-consuming charging processes.

In light thereof, electrical battery system 58 includes at least one battery regulator 59, which regulates the energy output of battery 58 such that only so much electrical energy is provided by battery 58 that the pump capacity of the hydraulic oil medium exactly matches the power required by wheel motors 53 to drive particular land wheel 13. According to detailed view B in FIG. 3, ground drive 2 of working platform 1 can be designed such that land wheels 13 are arranged in pairs, and a wheel motor 53a, 53b is assigned to each land wheel 13. In this context, it is feasible that one of paired wheel motors 53a, 53b provides only so much drive energy for land wheel 13 assigned to it that the rolling friction of land wheel 13 on ground 52 is just overcome, but land wheel 13 itself does not actively drive working platform 1.

In terms of reducing manufacturing costs, it is also feasible that a wheel motor 53a, 53b is assigned to only one of the paired land wheels 13, so that further land wheel 13 only ever performs a supporting function, and never a drive function. Given that all land wheels 13 are designed as Mecanum wheels, the highly flexible motion of working platform 1 is always ensured.

A high degree of stiffness of support means 3 through 5 and precise guidance of particular support means segments 6 through 8 is also attained when support means segments 6 through 8 have a prismatic cross-section 66, as shown in detailed view A in FIG. 3.

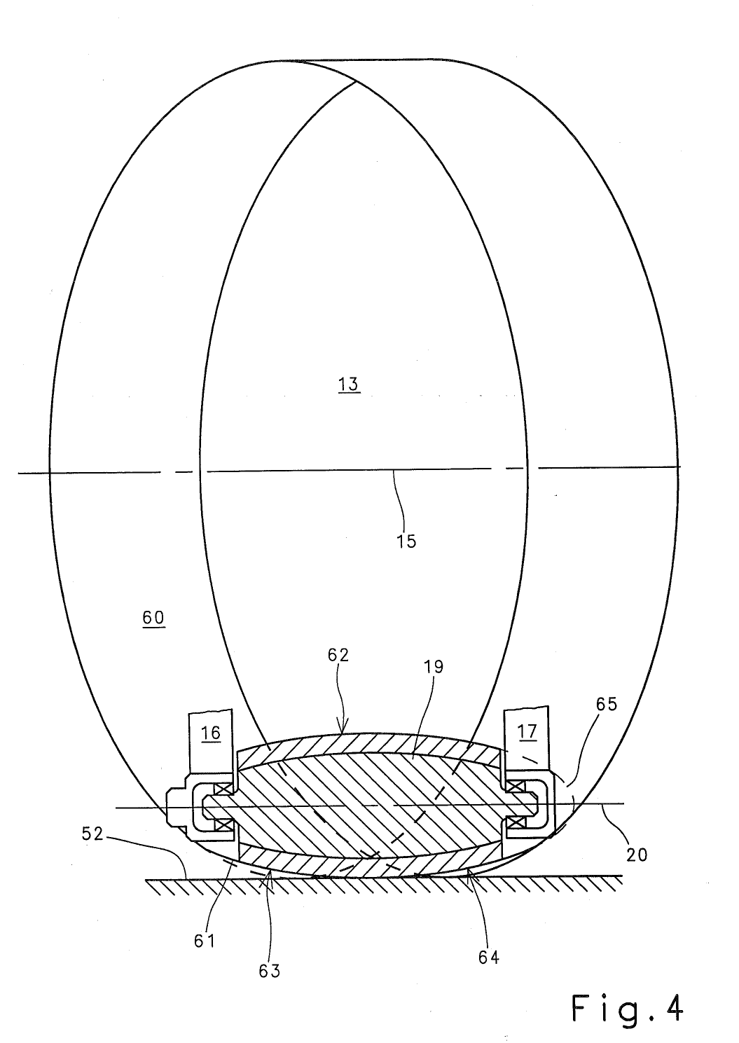

As described above, land wheels 13 are designed as Mecanum wheels, which enable highly precise guidance of working platform 1 on the ground due to rolling bodies 19 located around the circumference of each land wheel 13 and the associated overlap of rotational motions of wheel body 14 and rolling bodies 19. The high precision, combined with the very quiet running and low wear of land wheels 13 of this type, is promoted even further when rolling bodies 19 of land wheels 13 are designed as illustrated in FIG. 4.

As shown in FIG. 4, rolling bodies 19 assigned to land wheel describe a cylindrical envelope 60 when land wheel 13 rotates around its land wheel axle 15. Given that axes of rotation 20 of rolling bodies 19 are not in alignment with land wheel axle 15 of particular land wheel 13, i.e., they are not oriented in parallel in three dimensions, every rolling body 19 travels across ground 52 when land wheel 13 rotates such that the region of each rolling body 19 located in front—relative to the direction of rotation—comes in contact with ground 52, followed by the subsequent regions of each rolling body 19. This rolling motion results in a contact zone between rolling bodies 19 and ground 52, which is formed by a three-dimensional rolling track 61; the points on rolling track 61 represent the contact points between ground 52 and running surface 62 of particular rolling body 19.

Due to the slanted orientation of rolling bodies 19 relative to land wheel axle 15, a slice through envelope 60 in the direction of orientation of rotational axis 20 of a rolling body 19 results in a line of intersection 63 with an elliptical contour. Line of intersection 63 also defines the shape of rolling track 61 that would have to be attained for a rolling body 19 passing over ground 52 to have permanent contact with ground 52. Given that outer contour 64 of particular rolling body 19 has an elliptical shape 65 that corresponds to the elliptical contour of line of intersection 63 formed by envelope 60, this permanent contact of particular rolling body 19 with ground 52 is made possible, since line of intersection 63 corresponds to optimal rolling track 61.

It will be understood that each of the elements described above, or two or more together, may also find a useful application in other types of constructions differing from the type described above.

While the invention has been illustrated and described as embodied in a working platform, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A working platform, comprising a ground drive; a platform; telescoping support means having one end connected to said ground drive and another end connected to said platform; adjusting means for extending and retracting said telescoping support means for expanding and retracting said support means, said support means including support means segments which are at least partially nested inside each other, said adjusting means being assigned to a displaceable support means segment of said support means segments.

2. A working platform as defined in claim 1, wherein said support means include three support means segments which are at least partially nested inside each other, said adjusting means being assigned to a middle support means segments of said support means segments.

3. A working platform as defined in claim 1, wherein said adjusting means include a reciprocating cylinder system having at least one piston rod which is coupled with a chassis of said ground drive, and a piston rod coupled with said platform.

4. A working platform as defined in claim 3, wherein said reciprocating cylinder system includes a first reciprocating cylinder and a further reciprocating cylinder which are coupled with a same displaceable support means segment of said support means segments and with each other via a line system so that piston-rod side pressure chambers and piston-surface side pressure chambers of said reciprocating cylinders are interconnected.

5. A working platform as defined in claim 4, wherein said line system includes at least one non-return valve and one pressure reservoir unit.

6. A working platform as defined in claim 4, wherein said piston-rod side pressure chambers and said piston-surface side pressure chambers of said reciprocating cylinders assigned to corresponding ones of said support means are interconnected.

7. A working platform as defined in claim 3, wherein said piston rods of said adjusting means are configured as reciprocating cylinders in which a pressure reservoir medium is guided inside.

8. A working platform as defined in claim 7, and further comprising swivel joints which connect elements selected from the group consisting of said reciprocating cylinders, said support means segments, and both, connected with a chassis of said ground drive and said platform, to said chassis and said platform.

9. A working platform as defined in claim 8, wherein said swivel joints are configured as ball joints.

10. A working platform as defined in claim 8, wherein at least one of said swivel joints is configured as a compound slide joint.

11. A working platform as defined in claim 1, wherein said support means include at least three support means provided between said ground drive and said platform, which cross each other and connect said platform with said ground drive, at least two of said three support means being positioned in parallel with each other and at least one further support means of said three support means is located between said two parallel support means.

12. A working platform as defined in claim 1, further comprising a cable tension sensor assigned to each of said support means such that a guide cable detects a change in length of a respective one of said support means.

13. A working platform as defined in claim 1, further comprising a tilt sensor assigned to an element selected from the group consisting of said ground drive, said support means, said platform, and a combination thereof.

14. A working platform as defined in claim 1, further comprising a control and regulating unit which compares actual length signals, with which a change in length of a respective one of said support means is encoded, with target length signals, and the control and regulating unit generates stop signals if the actual length signals detected match the target length signals specified, to halt a motion of said support means segments.

15. A working platform as defined in claim 1, further comprising tilt sensors which generate tilt signals determining a tilt of said platform; a control and regulating unit which compares a change in a length of said support means encoded in actual length signals with target length signals taking into account the tilt of said platform, and the control and regulating unit generates stop signals if the actual length signals detected match the target length signal specified, to halt a motion of said support means signals.

16. A working platform as defined in claim 1, wherein said ground drive includes a plurality of land wheels, said land wheels including a wheel body formed by adjacent support elements, said support elements rotatably accommodating a plurality of rolling bodies between each other and on a peripheral circle, said rolling bodies extending at least partially beyond a circumference of said support elements and their axes of rotation are oriented diagonally to a land wheel axle of said wheel body.

17. A working platform as defined in claim 16, wherein at least one of said rolling bodies has an outer contour with an elliptical shape, wherein a geometry of an ellipse of said elliptical shape is adapted to a geometry of a cylindrical envelope described by said rolling bodies of said land wheel when it rotates around said wheel axle.

18. A working platform as defined in claim 16; further comprising at least one hydromotor for actively driving a respective one of said land wheels and assigned to each of said land wheels of said ground drive; and an electrical control circuit providing a hydraulic oil medium.

19. A working platform as defined in claim 1, wherein said ground drive includes a plurality of land wheels arranged in pairs, and a wheel motor assigned to at least one of said land wheels in a respective one of said pairs.

20. A working platform as defined in claim 19, wherein said wheel motor is assigned to each of said paired land wheels, and a drive of at least one of the wheel motors of said pairs wheels is limited to overcoming a rolling friction between a particular one of said land wheels and a ground.

21. A working platform as defined in claim 18, further comprising an electrical control circuit which operates using a battery; and a battery regulator assigned to said battery and providing only so much electrical energy that a pump capacity of a hydraulic oil medium exactly matches a power output of driven land wheels.

22. A working platform as defined in claim 1, wherein said support means segments that are at least partially nested inside of each other in a telescoping manner have a prismatic cross-section.
